(19) United States
(12) Patent Application Publication
(10) Pub. No.: US 2022/0014136 A1
(43) Pub. Date: Jan. 13, 2022

(54) MOTOR AND ELECTRIC POWER STEERING DEVICE

(71) Applicant: NIDEC CORPORATION, Kyoto (JP)

(72) Inventor: Hiromitsu OHASHI, Kyoto (JP)

(21) Appl. No.: 17/292,704

(22) PCT Filed: Oct. 29, 2019
(86) PCT No.: PCT/JP2019/042390

§ 371 Date: May 10, 2021

(30) Foreign Application Priority Data
Nov. 15, 2018 (JP) 2018-214496

(51) Int. Cl. H02P 25/22; H02P 27/08; B62D 5/04

(52) U.S. Cl. CPC H02P 25/22; H02P 2207/055; B62D 5/0403; H02P 27/08

(57) ABSTRACT

A motor includes: coil groups of n phases (n is an integer of three or more); a first inverter connected to one ends of the coil groups of n phases; a second inverter connected to the other ends of the coil groups of n phases; a stator around which the coil groups of n phases are wound; and a rotor that can rotate relative to the stator. At least one coil group of the coil groups of n phases includes a first sub coil group including a first coil and a second coil connected in series, and a second sub coil group including a third coil and a fourth coil connected in series. The first sub coil group and the second sub coil group are connected in parallel.

### CROSS-REFERENCE TO RELATED APPLICATIONS

This is the U.S. national stage of application No. PCT/JP2019/042390, filed on Oct. 29, 2019, and priority under 35 U.S.C. § 119(a) and 35 U.S.C. § 365(b) is claimed from Japanese Patent Application No. 2018-214496, filed on Nov. 15, 2018.

### FIELD OF THE INVENTION

The present disclosure relates to a motor and an electric power steering device.

### BACKGROUND

In recent years, a mechatronically integrated motor in which a motor, a power converter, and an ECU are integrated has been developed. Especially in the in-vehicle field, high quality assurance is required from the viewpoint of safety. For this reason, a redundant design is adopted that can continue safe operation even if a part of a component breaks down. As an example of redundant design, it is considered to provide two power converters for one motor. As another example, it is considered to provide a backup microcontroller as the main microcontroller.

For example, a power converter includes a control unit and two inverters, and converts electric power supplied to a three-phase motor. Each of the two inverters is connected to the power supply and ground (hereinafter referred to as “GND”). One inverter is connected to one ends of the three coils of the motor, and the other inverter is connected to the other ends of the three coils. Each inverter includes a bridge circuit formed of three legs, each containing a high-side switching element and a low-side switching element. Such a connection is sometimes called an independent connection. When the control unit detects a failure of the switching element of the two inverters, the control unit switches the motor control from normal control to abnormal control. In abnormal control, the neutral point of a coil is formed by turning on and off switching elements of the inverter including the failed switching element according to a predetermined rule, for example. Then, the motor drive is continued using the normal inverter.

### SUMMARY

An exemplary motor of the present disclosure is a motor including: coil groups of n phases (n is an integer of three or more); a first inverter connected to one ends of the coil groups of n phases; a second inverter connected to the other ends of the coil groups of n phases; a stator around which the coil groups of n phases are wound; and a rotor that can rotate relative to the stator, in which at least one coil group of the coil groups of n phases includes a first sub coil group including a first coil and a second coil connected in series, and a second sub coil group including a third coil and a fourth coil connected in series, and the first sub coil group and the second sub coil group are connected in parallel.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic diagram showing the structure of a motor according to an embodiment;

FIG. 2 is a schematic diagram showing the circuit configuration of the motor including a power converter according to the embodiment;

FIG. 3 is a diagram showing an H-bridge included in the power converter according to the embodiment;

FIG. 4 is a diagram showing an H-bridge included in the power converter according to the embodiment;

FIG. 5 is a diagram showing an H-bridge included in the power converter according to the embodiment;

FIG. 6 is a block diagram showing the motor including the power converter according to the embodiment;

FIG. 7 is a diagram showing current waveforms obtained by plotting the current values flowing in the coils of the U phase, V phase, and W phase of the motor when the power converter is controlled according to three-phase energization control according to the embodiment;

FIG. 8 is a diagram showing a stator and a rotor according to the embodiment;

FIG. 9 is a diagram showing the relationship between the wire diameter of the coil and the output according to the embodiment; and

FIG. 10 is a schematic diagram showing an electric power steering device according to the embodiment.

### DETAILED DESCRIPTION

Hereinafter, an embodiment of a motor and an electric power steering device including a power converter of the present disclosure will be described in detail with reference to the accompanying drawings. Note, however, that needlessly detailed descriptions may be omitted. For example, detailed descriptions of well-known matters and duplicate description of substantially the same configuration may be omitted. This is to avoid unnecessary redundancy of the following description and to facilitate the understanding of those skilled in the art.

In this specification, an embodiment will be described by taking a three-phase motor having coils of three phases (U-phase, V-phase, W-phase) as an example. Note, however, that n-phase motors having coils of n phases (n is an integer of three or more) such as four and five phases are also included in the present disclosure.

### Embodiment 1

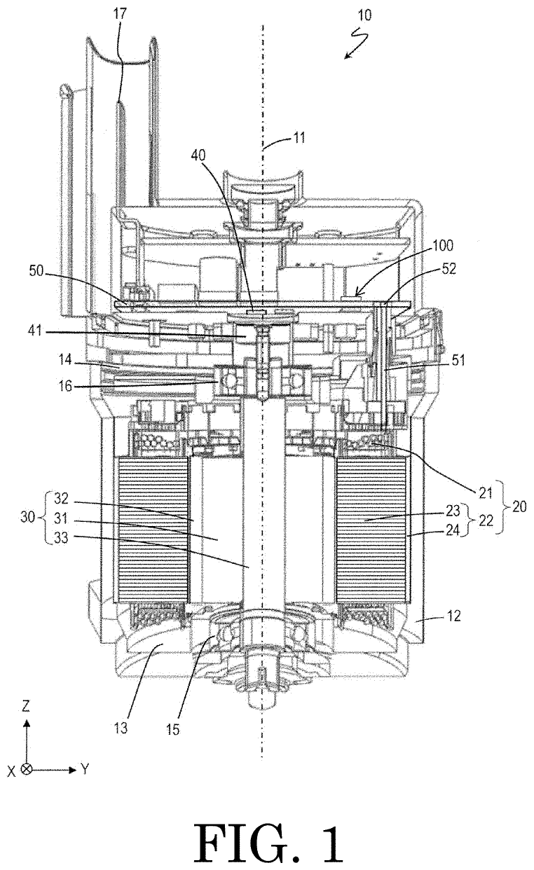

FIG. 1 is a diagram showing a structure of a motor 10 of the present embodiment. FIG. 1 shows the inside of the motor 10 when cut along a central axis 11.

The motor 10 is a mechatronically integrated motor. The motor 10 is used as a motor for an electric power steering device of an automobile, for example. In that case, the motor 10 generates the driving force of the electric power steering device. The motor 10 is a three-phase AC motor, for example.

The motor 10 includes a stator 20, a rotor 30, a housing 12, a partition wall 14, a bearing 15, and a bearing 16. The stator 20 is also referred to as an armature. The central axis 11 is the rotation axis of the rotor 30.

The housing 12 is a substantially cylindrical housing having a bottom, and houses the stator 20, the bearing 15, and the rotor 30 inside. A recess 13 for holding the bearing 15 is provided at the center of the bottom of the housing 12. The partition wall 14 is a plate-shaped member that closes an upper opening of the housing 12. The partition wall 14 holds the bearing 16 at the center thereof.

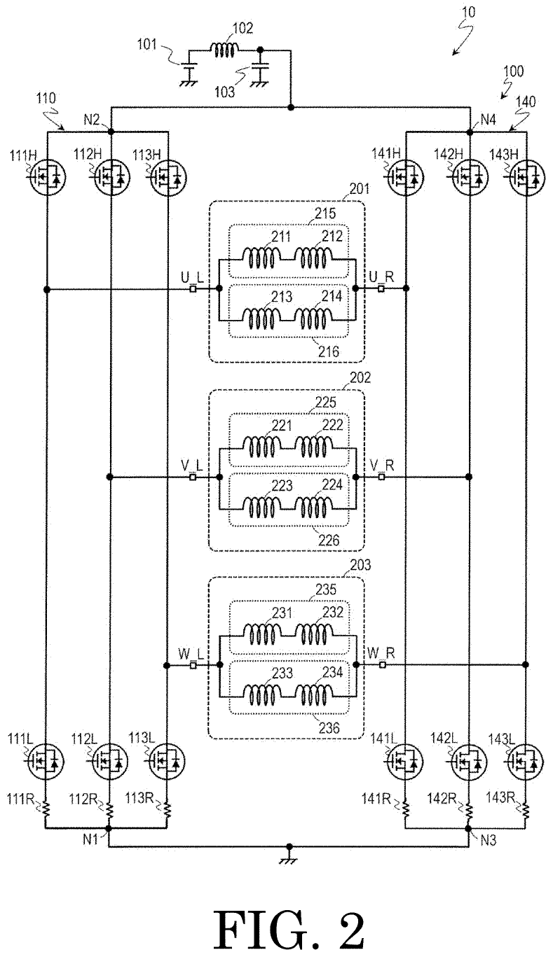

The stator 20 is annular and has a laminated body 22 and a coil 21. The laminated body 22 is also referred to as a laminated annular core. The coil is also referred to as a winding. The coil 21 corresponds to coil groups 201, 202, 203 (FIG. 2) described later. The stator 20 generates a magnetic flux in response to a drive current. The laminated body 22 is formed of a laminated steel plate in which multiple steel plates are laminated in a direction extending along the central axis 11 (direction Z in FIG. 1). The laminated body 22 includes an annular laminate core back 24 and multiple laminated teeth 23. The laminate core back 24 is fixed to an inner wall of the housing 12.

The coil 21 is made of a conductive material such as copper, and is typically attached to each of the multiple laminated teeth 23 of the laminated body 22.

The rotor 30 is rotatable about the central axis 11 relative to the stator 20. The rotor 30 includes a rotor core 31, multiple permanent magnets 32 provided along the outer circumference of the rotor core 31, and a shaft 33. The rotor core 31 is made of a magnetic material such as iron and has a tubular shape. In the present embodiment, the rotor core 31 is made of laminated steel plates in which multiple steel plates are laminated in a direction extending along the central axis 11 (direction Z in FIG. 1. 1). The multiple permanent magnets 32 are provided so that the north pole and the south pole appear alternately in the circumferential direction of the rotor core 31. The shaft 33 is fixed to the center of the rotor core 31 and extends in the vertical direction (direction Z) along the central axis 11. Note that the vertical and horizontal directions in the present specification are the vertical and horizontal directions when the motor 10 shown in FIG. 1 is viewed, and these directions will be used to facilitate the description of the embodiment. It goes without saying that the vertical and horizontal directions in the present specification do not always match the vertical and horizontal directions when the motor 10 is mounted on an actual product (automobile or the like).

The bearings 15 and 16 rotatably support the shaft 33 of the rotor 30. The bearings 15 and 16 are ball bearings that rotate an outer ring and an inner ring relative to each other through spheres, for example. FIG. 1 illustrates a ball bearing.

When a drive current is passed through the coil 21 of the stator 20 in the motor 10, magnetic flux in the radial direction is generated in the multiple laminated teeth 23 of the laminated body 22. Torque is generated in the circumferential direction by the action of the magnetic flux between the multiple laminated teeth 23 and the permanent magnets 32, and the rotor 30 rotates relative to the stator 20. When the rotor 30 rotates, a driving force is generated in the electric power steering device, for example.

A permanent magnet 41 is fixed to an end portion of the shaft 33 on the partition wall 14 side. The permanent magnet 41 can rotate together with the rotor 30. A substrate 50 is arranged on an upper part of the partition wall 14. A power converter 100 is mounted on the substrate 50. In the motor 10, the partition wall 14 separates the space in which the stator 20 and the rotor 30 are housed and the space in which the substrate 50 is housed.

The power converter 100 converts electric power from a power supply into electric power supplied to the coil 21 of the stator 20. The substrate 50 is provided with a terminal 52 of an inverter included in the power converter 100. An electric wire 51 is connected to the terminal 52. The electric wire 51 is an end portion of the coil 21, for example. The electric wire 51 and the coil 21 may be separate members. Electric power output from the power converter 100 is supplied to the coil 21 through the electric wire 51. Details of the power converter 100 will be described later.

A magnetic sensor 40 is provided on the substrate 50. The magnetic sensor 40 is arranged at a position facing the permanent magnet 41 fixed to the shaft 33. The magnetic sensor 40 is arranged on the central axis 11 of the shaft 33. The magnetic sensor 40 is a magnetoresistance effect element or a Hall element, for example. The magnetic sensor 40 detects a magnetic field generated from the permanent magnet 41 rotating together with the shaft 33, whereby the rotation angle of the rotor 30 can be detected.

The motor 10 is connected to various control devices, batteries, and the like outside the motor 10 through multiple terminals 17. The multiple terminals 17 include a power supply terminal to which electric power is supplied from an external power supply, a signal terminal for transmitting and receiving data to and from an external device, and the like.

Next, details of the motor 10 including the power converter 100 will be described.

FIG. 2 schematically shows the circuit configuration of the motor 10 including the power converter 100 of the present embodiment.

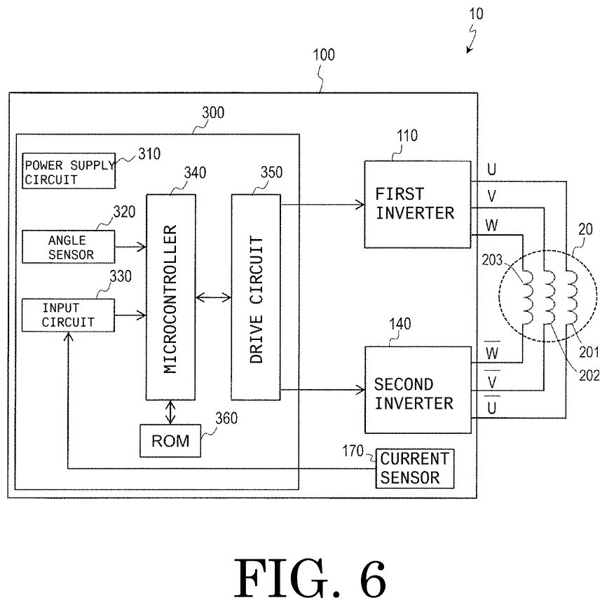

The power converter 100 includes a first inverter 110 and a second inverter 140. Additionally, the power converter 100 includes a control circuit 300 shown in FIG. 6.

As the coil 21 (FIG. 1), a U-phase coil group 201, a V-phase coil group 202, and a W-phase coil group 203 are wound around the stator 20. The coil group of each phase is connected to the first inverter 110 and the second inverter 140. Specifically, the first inverter 110 is connected to one end of the coil group of each phase, and the second inverter 140 is connected to the other end of the coil group of each phase. In the present specification, “connection” between components in an electrical circuit primarily means an electrical connection.

The U-phase coil group 201 includes a sub coil group 215 and a sub coil group 216. The sub coil group 215 includes a coil 211 and a coil 212 connected in series. The sub coil group 216 includes a coil 213 and a coil 214 connected in series. The sub coil group 215 and the sub coil group 216 are connected in parallel. In other words, the coils 211 and 212 connected in series and the coils 213 and 214 connected in series are connected in parallel.

The V-phase coil group 202 includes a sub coil group 225 and a sub coil group 226. The sub coil group 225 includes a coil 221 and a coil 222 connected in series. The sub coil group 226 includes a coil 223 and a coil 224 connected in series. The sub coil group 225 and the sub coil group 226 are connected in parallel. In other words, the coils 221 and 222 connected in series and the coils 223 and 224 connected in series are connected in parallel.

The W-phase coil group 203 includes a sub coil group 235 and a sub coil group 236. The sub coil group 235 includes a coil 231 and a coil 232 connected in series. The sub coil group 236 includes a coil 233 and a coil 234 connected in series. The sub coil group 235 and the sub coil group 236 are connected in parallel. In other words, the coils 231 and 232 connected in series and the coils 233 and 234 connected in series are connected in parallel.

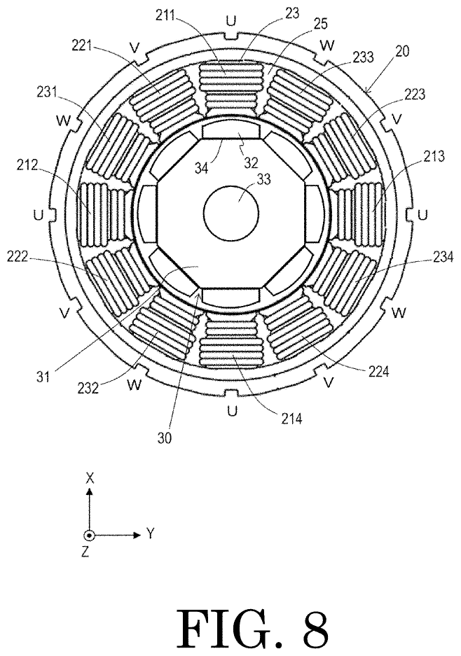

FIG. 8 is a diagram showing an example of the stator 20 and the rotor 30. In this example, the stator 20 includes 12 teeth 23. The rotor 30 includes eight permanent magnets 32. In other words, in this example, the stator 20 has 12 grooves (slots) 25 that are formed between adjacent teeth 23 and in which the coil 21 is arranged. There are eight poles in the rotor 30. Such a structure with 12 slots and eight magnetic poles is sometimes referred to as 8P12S (8 poles, 12 slots). In this example, the motor 10 is a three-phase motor with windings of three phases (U-phase, V-phase, W-phase). For example, the U phase, V phase, and W phase are assigned to the 12 teeth 23 in the order of U, V, W, U, V, W, U, V, W, U, V, and W.

The outer shape of the rotor core 31 is polygonal in plan view when the rotor 30 is viewed from a direction parallel to the rotation axis direction of the rotor 30. In this example, the outer shape of the rotor core 31 in plan view is octagonal. An outer peripheral portion of the rotor core 31 has multiple side surfaces 34. In this example, the outer peripheral portion of the rotor core 31 has eight side surfaces 34. The eight side surfaces 34 are arranged adjacent to one another in the circumferential direction of the rotor core 31 to form an outer surface of the rotor core 31. In plan view, each side surface 34 has a linear shape.

The permanent magnets 32 are arranged on each of the side surfaces 34. The permanent magnet 32 is fixed to the side surface 34 by an adhesive or the like. Each permanent magnet 32 faces a corresponding tooth 23 in the radial direction. Note that the permanent magnet 32 may be held by the rotor core 31 using a member such as a magnet holder, or may be fixed by another method.

The coil winding scheme of the stator 20 is concentrated winding, for example. For example, the coil 211, the coil 212, the coil 213, and the coil 214 are wound around the multiple laminated teeth 23 to which a U phase is assigned. The coil 221, the coil 222, the coil 223, and the coil 224 are wound around the multiple laminated teeth 23 to which a V phase is assigned. The coil 231, the coil 232, the coil 233, and the coil 234 are wound around the multiple laminated teeth 23 to which the W phase is assigned.

Note that the number of magnetic poles and the number of slots described above are examples, and may be different numbers. For example, the number of magnetic poles may be 10, 14, or 16.

The first inverter 110 has terminals U_L, V_L, and W_L corresponding to the phases as the terminals 52 (FIG. 1). The second inverter 140 has terminals U R, V R, and W R corresponding to the phases as the terminals 52. Of the first inverter 110, the terminal U_L is connected to one end of the U-phase coil group 201, the terminal V_L is connected to one end of the V-phase coil group 202, and the terminal W_L is connected to one end of the W-phase coil group 203. Similar to the first inverter 110, of the second inverter 140, the terminal U R is connected to the other end of the U-phase coil group 201, the terminal V R is connected to the other end of the V-phase coil group 202, and the terminal W R is connected to the other end of the W-phase coil group 203. Unlike the so-called star connection and delta connection, such a connection is sometimes referred to as an independent connection.

Note that a sub coil group of the same phase may be connected to the first inverter 110 and the second inverter 140 in a state of being connected to each other, or may be connected to the first inverter 110 and the second inverter 140 independently of each other. For example, the coil 211 and the coil 213 may be connected to the first inverter 110 while being connected to each other, or the coil 211 and the coil 213 may be connected to the first inverter 110 independently of each other. Additionally, for example, the coil 212 and the coil 214 may be connected to the second inverter 140 while being connected to each other, or the coil 212 and the coil 214 may be connected to the second inverter 140 independently of each other.

In the power converter 100, the first inverter 110 and the second inverter 140 are connected to a power supply 101 and GND. The motor 10 including the power converter 100 may be connected to an external power supply, through the terminal 17 (FIG. 1), for example.

In the present specification, the first inverter 110 may be denoted as “bridge circuit L”. Additionally, the second inverter 140 may be denoted as “bridge circuit R”. Each of the first inverter 110 and the second inverter 140 includes three legs including a low-side switching element and a high-side switching element. The multiple switching elements forming these legs form multiple H bridges between the first inverter 110 and the second inverter 140 through the coil groups of the motor 10.

The first inverter 110 includes a bridge circuit formed of three legs. In FIG. 2, switching elements 111L, 112L, and 113L are low-side switching elements, and switching elements 111H, 112H, and 113H are high-side switching elements. A field effect transistor (typically a MOSFET) or an insulated gate bipolar transistor (IGBT) can be used as the switching element, for example. In the present specification, an example of using a FET as a switching element of the inverter will be described, and in the following description, a switching element may be denoted as a FET. For example, the switching element 111L is denoted as the FET 111L.

The first inverter 110 includes three shunt resistors 111R, 112R, and 113R as current sensors (see FIG. 6) for detecting the current flowing through the coil groups of the U phase, V phase, and W phase. A current sensor 170 includes a current detection circuit (not shown) that detects the current flowing through each shunt resistor. For example, the shunt resistors 111R, 112R, and 113R are connected between the three low-side switching elements included in the three legs of the first inverter 110 and GND. Specifically, the shunt resistor 111R is connected between the FET 111L and GND, the shunt resistor 112R is connected between the FET 112L and GND, and the shunt resistor 113R is connected between the FET 113L and GND. The resistance value of the shunt resistor is about 0.5 mΩ to 1.0 mΩ, for example.

Like the first inverter 110, the second inverter 140 includes a bridge circuit formed of three legs. In FIG. 2, FETs 141L, 142L, and 143L are low-side switching elements, and FETs 141H, 142H, and 143H are high-side switching elements. Additionally, the second inverter 140 includes three shunt resistors 141R, 142R, and 143R. These shunt resistors are connected between the three low-side switching elements included in the three legs and GND. Each FET of the first and second inverters 110 and 140 can be controlled by a microcontroller or a dedicated driver, for example.

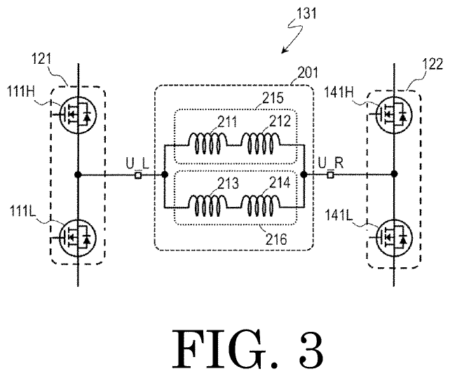

FIGS. 3, 4, and 5 are diagrams showing three H-bridges 131, 132, and 133 included in the power converter 100.

The first inverter 110 has legs 121, 123, and 125. The leg 121 has the FET 111H and the FET 111L. The leg 123 has the FET 112H and the FET 112L. The leg 125 has the FET 113H and the FET 113L.

The second inverter 140 has legs 122, 124 and 126. The leg 122 has the FET 141H and the FET 141L. The leg 124 has the FET 142H and the FET 142L. The leg 126 has the FET 143H and the FET 143L.

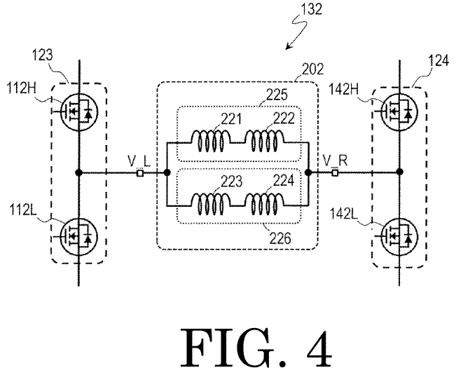

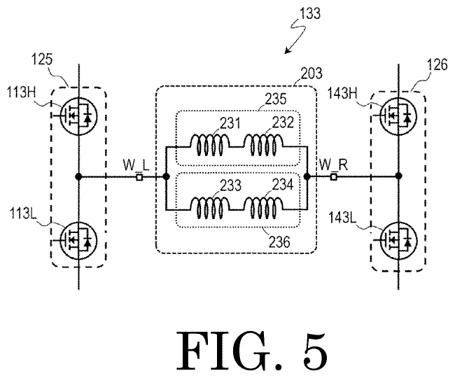

The H-bridge 131 shown in FIG. 3 has the leg 121, the coil group 201, and the leg 122. The H-bridge 132 shown in FIG. 4 has the leg 123, the coil group 202, and the leg 124. The H-bridge 133 shown in FIG. 5 has the leg 125, the coil group 203, and the leg 126.

The power supply 101 (FIG. 2) generates a predetermined power supply voltage. Electric power is supplied to the first and second inverters 110, 140 from the power supply 101. A DC power supply is used as the power supply 101, for example. Note, however, that the power supply 101 may be an AC-DC converter or a DC-DC converter, or may be a battery (storage battery). The power supply 101 may be a single power supply common to the first and second inverters 110, 140, or may include a first power supply for the first inverter 110 and a second power supply for the second inverter 140.

A coil 102 is provided between the power supply 101 and the power converter 100. The coil 102 functions as a noise filter and smoothes high-frequency noise included in the voltage waveform supplied to each inverter or high-frequency noise generated by each inverter so as not to flow out to the power supply 101 side. Additionally, one end of a capacitor 103 is connected between the power supply 101 and the power converter 100. The other end of the capacitor 103 is connected to GND. The capacitor 103 is a so-called bypass capacitor and curbs voltage ripple. The capacitor 103 is an electrolytic capacitor, for example, and the capacitance and the number of capacitors to be used are appropriately determined by design specifications and the like.

FIG. 2 illustrates a configuration in which one shunt resistor is arranged on each leg of each inverter. The first and second inverters 110, 140 may include six or less shunt resistors. The six or less shunt resistors may be connected between GND and six or less low-side switching elements out of the six legs of the first and second inverters 110, 140. Further, extending this to an n-phase motor, the first and second inverters 110, 140 may include 2n or less shunt resistors. The 2n or less shunt resistors may be connected between GND and 2n or less low-side switching elements out of the 2n legs of the first and second inverters 110, 140.

FIG. 6 schematically shows a block configuration of the motor 10 including the power converter 100. The power converter 100 includes the control circuit 300.

The control circuit 300 includes a power supply circuit 310, an angle sensor 320, an input circuit 330, a microcontroller 340, a drive circuit 350, and a ROM 360, for example. The control circuit 300 drives the motor 10 by controlling the overall operation of the power converter 100. Specifically, the control circuit 300 can achieve closed loop control by controlling the position, rotation speed, current, and the like of the target rotor. Note that the control circuit 300 may include a torque sensor instead of the angle sensor. In this case, the control circuit 300 can control the target motor torque.

The power supply circuit 310 generates the required DC voltage (e.g., 3V, 5V) for each block in the circuit. The angle sensor 320 is a resolver or a Hall IC, for example. A magnetoresistance effect element and a magnet may be used as the angle sensor 320. The angle sensor 320 detects the rotation angle (hereinafter denoted as “rotation signal”) of the rotor of the motor 10, and outputs the rotation signal to the microcontroller 340. The input circuit 330 receives the motor current value (hereinafter denoted as “actual current value”) detected by the current sensor 170, converts the level of the actual current value into an input level of the microcontroller 340 as necessary, and outputs the actual current value to the microcontroller 340.

The microcontroller 340 controls the switching operation (turn-on or turn-off) of each FET of the first inverter 110 and the second inverter 140. The microcontroller 340 sets a target current value according to the actual current value and the rotation signal of the rotor, generates a PWM signal, and outputs the PWM signal to the drive circuit 350.

The drive circuit 350 is typically a gate driver. The drive circuit 350 generates a control signal (gate control signal) for controlling the switching operation of each FET in the first and second inverters 110, 140 according to the PWM signal, and gives a control signal to the gate of each FET. Note that the microcontroller 340 may have the function of the drive circuit 350. In that case, the control circuit 300 does not have to include the drive circuit 350.

The ROM 360 is a writable memory, a rewritable memory, or a read-only memory, for example. The ROM 360 stores a control program including a set of instructions for causing the microcontroller 340 to control the power converter 100. For example, the control program is temporarily expanded to a RAM (not shown) at boot time.

Next, a specific example of the control method of the power converter 100 will be described. The control circuit 300 drives the motor 10 by performing three-phase energization control using both the first and second inverters 110, 140. Specifically, the control circuit 300 performs three-phase energization control by switching the FET of the first inverter 110 and the FET of the second inverter 140 to opposite phases (phase difference=180°). For example, focusing on the H-bridge including the FETs 111L, 111H, 141L, and 141H, when the FET 111L is turned on, the FET 141L is turned off, and when the FET 111L is turned off, the FET 141L is turned on. Similarly, when the FET 111H is turned on, the FET 141H is turned off, and when the FET 111H is turned off, the FET 141H is turned on. The current output from the power supply 101 flows to GND through the high-side switching element, the coil group, and the low-side switching element.

Here, the route of the current flowing through the U-phase coil group 201 will be described. When the FET 111H and the FET 141L are on and the FET 141H and the FET 111L are off, the current flows in the order of the power supply 101, the FET 111H, the coil group 201, the FET 141L, and GND. When the FET 141H and the FET 111L are on and the FET 111H and the FET 141L are off, the current flows in the order of the power supply 101, the FET 141H, the coil group 201, the FET 111L, and GND.

Next, the route of the current flowing through the V-phase coil group 202 will be described. When the FET 112H and the FET 142L are on and the FET 142H and the FET 112L are off, the current flows in the order of the power supply 101, the FET 112H, the coil group 202, the FET 142L, and GND. When the FET 142H and the FET 112L are on and the FET 112H and the FET 142L are off, the current flows in the order of the power supply 101, the FET 142H, the coil group 202, the FET 112L, and GND.

Next, the route of the current flowing through the W-phase coil group 203 will be described. When the FET 113H and the FET 143L are on and the FET 143H and the FET 113L are off, the current flows in the order of the power supply 101, the FET 113H, the coil group 203, the FET 143L, and GND. When the FET 143H and the FET 113L are on and the FET 113H and the FET 143L are off, the current flows in the order of the power supply 101, the FET 143H, the coil group 203, the FET 113L, and GND.

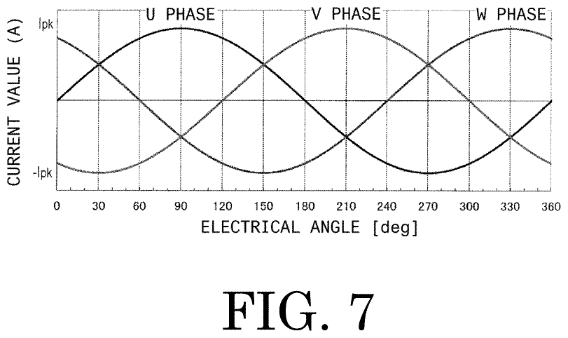

FIG. 7 illustrates current waveforms (sine waves) obtained by plotting the current values flowing in the coil groups of the U phase, V phase, and W phase of the motor 10 when the power converter 100 is controlled according to the three-phase energization control. The horizontal axis represents the motor electrical angle (deg), and the vertical axis represents the current value (A). In the current waveform of FIG. 7, the current value is plotted every 30° of the electrical angle. Here, Iₚₖ represents the maximum current value (peak current value) of each phase.

Table 1 shows the current values flowing through the terminals of each inverter for each electrical angle in the sine wave of FIG. 7. Specifically, Table 1 shows the current values flowing through the terminals U_L, V_L, and W_L of the first inverter 110 (bridge circuit L) at every electrical angle of 30°, and the current values flowing through the terminals U R, V R, and W R of the second inverter 140 (bridge circuit R) at every electrical angle of 30°. Here, for the bridge circuit L, the direction of the current flowing from the terminal of the bridge circuit L to the terminal of the bridge circuit R is defined as the positive direction. The direction of the current shown in FIG. 7 follows this definition. Meanwhile, for the bridge circuit R, the direction of the current flowing from the terminal of the bridge circuit R to the terminal of the bridge circuit L is defined as the positive direction. Accordingly, the phase difference between the current of the bridge circuit L and the current of the bridge circuit R is 180°. In Table 1, the magnitude of a current value I₁ is [(3)^{1/2}/2]*Iₚₖ, and the magnitude of a current value I₂ is Iₚₖ/2.

TABLE 1

| | | Electrical angle [deg] | | | | | | | | | | | |
|---|---|---|---|---|---|---|---|---|---|---|---|---|---|
| | | 0 | | | | | | | | | | | |
| | | (360) | 30 | 60 | 90 | 120 | 150 | 180 | 210 | 240 | 270 | 300 | 330 |
| Bridge | U_L | 0 | I₂ | I₁ | Iₚₖ | I₁ | I₂ | 0 | −I₂ | −I₁ | −Iₚₖ | −I₁ | −I₂ |
| circuit L | phase | | | | | | | | | | | | |
| | V_L | −I₁ | −Iₚₖ | −I₁ | −I₂ | 0 | I₂ | I₁ | Iₚₖ | I₁ | I₂ | 0 | −I₂ |
| | phase | | | | | | | | | | | | |
| | W_L | I₁ | I₂ | 0 | −I₂ | −I₁ | −Iₚₖ | −I₁ | −I₂ | 0 | I₂ | I₁ | Iₚₖ |
| | phase | | | | | | | | | | | | |
| Bridge | U_R | 0 | −I₂ | −I₁ | −Iₚₖ | −I₁ | −I₂ | 0 | I₂ | I₁ | Iₚₖ | I₁ | I₂ |
| circuit R | phase | | | | | | | | | | | | |
| | V_R | I₁ | Iₚₖ | I₁ | I₂ | 0 | −I₂ | −I₁ | −Iₚₖ | −I₁ | −I₂ | 0 | I₂ |
| | phase | | | | | | | | | | | | |
| | W_R | −I₁ | −I₂ | 0 | I₂ | I₁ | Iₚₖ | I₁ | I₂ | 0 | −I₂ | −I₁ | −Iₚₖ |
| | phase | | | | | | | | | | | | |

At an electrical angle of 0°, no current flows through the U-phase coil group 201. A current of magnitude I₁ flows from the bridge circuit R to the bridge circuit L in the V-phase coil group 202, and a current of magnitude I₁ flows from the bridge circuit L to the bridge circuit R in the W-phase coil group 203.

At an electrical angle of 30°, a current of magnitude 12 flows from the bridge circuit L to the bridge circuit R in the U-phase coil group 201, a current of magnitude Ipk flows from the bridge circuit R to the bridge circuit L in the V-phase coil group 202, and a current of magnitude I₂ flows from the bridge circuit L to the bridge circuit R in the W-phase coil group 203.

At an electrical angle of 60°, a current of magnitude I₁ flows from the bridge circuit L to the bridge circuit R in the U-phase coil group 201, and a current of magnitude I₁ flows from the bridge circuit R to the bridge circuit L in the V-phase coil group 202. No current flows through the W-phase coil group 203.

At an electrical angle of 90°, a current of magnitude Ipk flows from the bridge circuit L to the bridge circuit R in the U-phase coil group 201, a current of magnitude I₂ flows from the bridge circuit R to the bridge circuit L in the V-phase coil group 202, and a current of magnitude I₂ flows from the bridge circuit R to the bridge circuit L in the W-phase coil group 203.

At an electrical angle of 120°, a current of magnitude I₁ flows from the bridge circuit L to the bridge circuit R in the U-phase coil group 201, and a current of magnitude I₁ flows from the bridge circuit R to the bridge circuit L in the W-phase coil group 203. No current flows through the V-phase coil group 202.

At an electrical angle of 150°, a current of magnitude I₂ flows from the bridge circuit L to the bridge circuit R in the U-phase coil group 201, a current of magnitude I₂ flows from the bridge circuit L to the bridge circuit R in the V-phase coil group 202, and a current of magnitude Ipk flows from the bridge circuit R to the bridge circuit L in the W-phase coil group 203.

At an electrical angle of 180°, no current flows through the U-phase coil group 201. A current of magnitude I₁ flows from the bridge circuit L to the bridge circuit R in the V-phase coil group 202, and a current of magnitude I₁ flows from the bridge circuit R to the bridge circuit L in the W-phase coil group 203.

At an electrical angle of 210°, a current of magnitude I₂ flows from the bridge circuit R to the bridge circuit L in the U-phase coil group 201, a current of magnitude Ipk flows from the bridge circuit L to the bridge circuit R in the V-phase coil group 202, and a current of magnitude I₂ flows from the bridge circuit R to the bridge circuit L in the W-phase coil group 203.

At an electrical angle of 240°, a current of magnitude I₁ flows from the bridge circuit R to the bridge circuit L in the U-phase coil group 201, and a current of magnitude I₁ flows from the bridge circuit L to the bridge circuit R in the V-phase coil group 202. No current flows through the W-phase coil group 203.

At an electrical angle of 270°, a current of magnitude Ipk flows from the bridge circuit R to the bridge circuit L in the U-phase coil group 201, a current of magnitude I₂ flows from the bridge circuit L to the bridge circuit R in the V-phase coil group 202, and a current of magnitude I₂ flows from the bridge circuit L to the bridge circuit R in the W-phase coil group 203.

At an electrical angle of 300°, a current of magnitude I₁ flows from the bridge circuit R to the bridge circuit L in the U-phase coil group 201, and a current of magnitude I₁ flows from the bridge circuit L to the bridge circuit R in the W-phase coil group 203. No current flows through the V-phase coil group 202.

At an electrical angle of 330°, a current of magnitude I₂ flows from the bridge circuit R to the bridge circuit L in the U-phase coil group 201, a current of magnitude I₂ flows from the bridge circuit R to the bridge circuit L in the V-phase coil group 202, and a current of magnitude Ipk flows from the bridge circuit L to the bridge circuit R in the W-phase coil group 203.

For example, the control circuit 300 controls the switching operation of each FET of the bridge circuits L and R by performing PWM control that results in the current waveform shown in FIG. 7.

As described above, the motor is required to have a large output. In particular, in an in-vehicle motor, the output is to be increased at the voltage level supplied from the battery.

According to research by the inventors of the present application, it has been found that a motor adopting the above-mentioned independent connection scheme can generate a larger phase voltage than a motor adopting the star connection scheme and a motor adopting the delta connection scheme.

In a motor adopting the independent connection scheme, in order to further increase the output, it is conceivable to increase the magnitude of the current to be passed. If a large current is to be passed, it is necessary to increase the wire diameter of the coil. However, when the wire diameter of the coil is increased, it becomes difficult to wind the coil around the laminated teeth of the stator. Additionally, since the minimum bending radius of a coil is generally proportional to the wire diameter, the larger the wire diameter, the larger the coil end. Moreover, as the wire diameter of a coil increases, the gap between coils increases, which causes a decrease in torque.

In the coil group of the present embodiment, two coils connected in series and two other coils connected in series are connected in parallel. For example, four coils are wound around four laminated teeth 23 to which the same phase is assigned. As a result, the wire diameter of the coil can be reduced. In other words, the cross-sectional area of the coil can be reduced. For example, in the motor 10 with the stator 20 having an outer diameter of 70 mm to 100 mm, a coil having a wire diameter of 1.2 mm to 2.0 mm can be used. The cross-sectional area of the coil in this case is 1.13 mm² to 3.14 mm². Additionally, for example, in the motor 10 having an outer diameter of 85 mm and a length of 36 mm in the rotation axis direction, a coil having a wire diameter of 1.8 mm or less can be used to increase the output. Since the wire diameter of the coil can be reduced, it becomes easy to wind the coil around the laminated teeth 23. Additionally, since the minimum bending radius of the coil can be reduced, the coil end can be reduced.

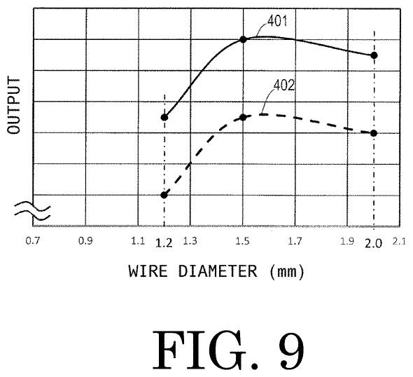

FIG. 9 is a diagram showing the relationship between the wire diameter of the coil and the output. The vertical axis of FIG. 9 represents the output of the normalized motor, and the horizontal axis represents the wire diameter of the coil. A solid line 401 in FIG. 9 shows the relationship between the wire diameter of the coil and the output in the independent connection type motor 10 of the present embodiment. A broken line 402 in FIG. 9 shows the relationship between the wire diameter and the output of a coil in a star connection type motor which is a comparative example. As shown in FIG. 9, it can be seen that the output of the independent connection type motor 10 is large in the range of the coil wire diameter of 1.2 mm to 2.0 mm. As described above, the motor 10 adopting the independent connection scheme can have a larger output than a motor adopting another connection scheme.

Note that It is also conceivable to connect all four coils assigned to one phase in parallel. For example, it is conceivable to connect all four coils 211, 212, 213, 214 assigned to the U phase in parallel. However, if all the coils are connected in parallel, the number of connections will increase and the manufacturing cost will increase. In comparison, in the configuration of the coil groups 201, 202, 203 of the present embodiment, the number of connections can be reduced and the manufacturing cost can be reduced.

With the motor 10 of the present embodiment, a larger phase voltage can be generated with less connections. Hence, output can be increased. Additionally, if the required output is the same, the size of the motor 10 of the present embodiment can be made smaller than that of the conventional motor.

### Embodiment 2

Vehicles such as automobiles are generally equipped with an electric power steering device. An electric power steering device generates auxiliary torque for assisting steering torque of a steering system generated by the driver operating a steering handle. The auxiliary torque is generated by an auxiliary torque mechanism, and can reduce the burden on the driver's operation. For example, an auxiliary torque mechanism includes a steering torque sensor, an ECU, a motor, a reduction mechanism, and the like. The steering torque sensor detects the steering torque in the steering system. The ECU generates a drive signal on the basis of a detection signal of the steering torque sensor. The motor generates auxiliary torque according to the steering torque on the basis of the drive signal, and transmits the auxiliary torque to the steering system through the reduction mechanism.

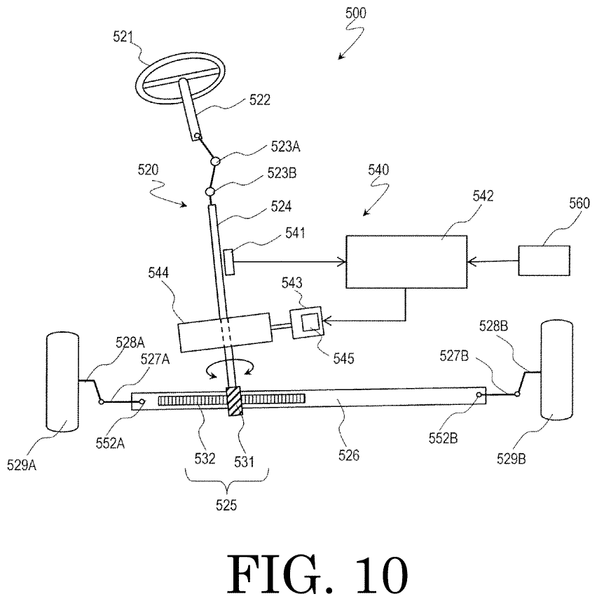

The motor 10 of the present disclosure is suitably used for an electric power steering device. FIG. 10 schematically shows an electric power steering device 500 according to the present embodiment. The electric power steering device 500 includes a steering system 520 and an auxiliary torque mechanism 540.

The steering system 520 includes, for example, a steering handle 521, a steering shaft 522 (also referred to as “steering column”), universal couplings 523A, 523B, a rotating shaft 524 (also referred to as “pinion shaft” or “input shaft”), a rack and pinion mechanism 525, a rack shaft 526, right and left ball joints 552A, 552B, tie rods 527A, 527B, knuckles 528A, 528B, and right and left steered wheels (e.g., right and left front wheels) 529A, 529B. The steering handle 521 is connected to the rotating shaft 524 through the steering shaft 522 and the universal couplings 523A, 523B. The rack shaft 526 is connected to the rotating shaft 524 through the rack and pinion mechanism 525. The rack and pinion mechanism 525 has a pinion 531 provided on the rotating shaft 524 and a rack 532 provided on the rack shaft 526. The right steered wheel 529A is connected to the right end of the rack shaft 526 through the ball joint 552A, the tie rod 527A, and the knuckle 528A in this order. Similar to the right side, the left steered wheel 529B is connected to the left end of the rack shaft 526 through the ball joint 552B, the tie rod 527B, and the knuckle 528B in this order. Here, the right side and the left side correspond to the right side and the left side as seen from the driver sitting in the seat, respectively.

According to the steering system 520, steering torque is generated when the driver operates the steering handle 521, and is transmitted to the right and left steered wheels 529A, 529B through the rack and pinion mechanism 525. As a result, the driver can operate the right and left steered wheels 529A, 529B.

The auxiliary torque mechanism 540 includes, for example, a steering torque sensor 541, an ECU 542, a motor 543, a reduction mechanism 544, and a power converter 545. The auxiliary torque mechanism 540 applies auxiliary torque to the steering system 520 from the steering handle 521 to the right and left steered wheels 529A, 529B. Note that auxiliary torque is sometimes referred to as “additional torque”.

The control circuit 300 according to the embodiment can be used as the ECU 542, and the power converter 100 according to the embodiment can be used as the power converter 545. Additionally, the motor 543 corresponds to the motor 10 of the embodiment. The motor 10 according to the embodiment can be preferably used as a mechatronically integrated unit including the ECU 542, the motor 543, and the power converter 545.

The steering torque sensor 541 detects the steering torque of the steering system 520 applied by the steering handle 521. The ECU 542 generates a drive signal for driving the motor 543 on the basis of a detection signal (hereinafter referred to as “torque signal”) from the steering torque sensor 541. The motor 543 generates auxiliary torque according to the steering torque on the basis of the drive signal. The auxiliary torque is transmitted to the rotating shaft 524 of the steering system 520 through the reduction mechanism 544. The reduction mechanism 544 is a worm gear mechanism, for example. The auxiliary torque is further transmitted to the rack and pinion mechanism 525 from the rotating shaft 524.

The electric power steering device 500 can be classified into a pinion assist type, a rack assist type, a column assist type, and the like, depending on where the auxiliary torque is applied in the steering system 520. FIG. 10 illustrates a pinion assist type electric power steering device 500. Note, however, that the electric power steering device 500 may be a rack assist type, a column assist type, or the like.

Not only a torque signal but also a vehicle speed signal, for example, can be input to the ECU 542. An external device 560 is a vehicle speed sensor, for example. Alternatively, the external device 560 may be another ECU that can be reached through an in-vehicle network such as CAN (controller area network). The microcontroller of the ECU 542 can control the motor 543 by vector control or the like on the basis of a torque signal, a vehicle speed signal, or the like.

The ECU 542 sets a target current value at least based on the torque signal. It is preferable that the ECU 542 sets the target current value in consideration of the vehicle speed signal detected by a vehicle speed sensor and also in consideration of the rotation signal of a rotor detected by an angle sensor 320. The ECU 542 can control the drive signal, that is, the drive current of the motor 543 so that the actual current value detected by the current sensor 170 matches the target current value.

According to the electric power steering device 500, the right and left steered wheels 529A, 529B can be operated by the rack shaft 526 by utilizing the combined torque obtained by adding the auxiliary torque of the motor 543 to the steering torque of the driver. In particular, by using the motor 10 of the present disclosure for the above-mentioned mechatronically integrated unit, it is possible to provide an electric power steering device with a motor that includes components with improved quality and is capable of appropriate current control in both normal and abnormal times.

The embodiments according to the present disclosure have been described above. The above description of the embodiments is exemplary and does not limit the technique of the present disclosure. Additionally, embodiments appropriately combining the components described in the above embodiments are also conceivable.

The embodiments of the present disclosure can be widely used for various devices including various motors such as a vacuum cleaner, a dryer, a ceiling fan, a washing machine, a refrigerator, and an electric power steering device.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A motor comprising:
coil groups of n phases (n is an integer of three or more);
a first inverter connected to one ends of the coil groups of n phases;
a second inverter connected to the other ends of the coil groups of n phases;
a stator around which the coil groups of n phases are wound; and
a rotor that can rotate relative to the stator, wherein
at least one coil group of the coil groups of n phases includes
a first sub coil group including a first coil and a second coil connected in series, and
a second sub coil group including a third coil and a fourth coil connected in series, and
the first sub coil group and the second sub coil group are connected in parallel.

2. The motor according to claim 1, wherein the winding scheme of the coil of the stator is concentrated winding.

3. The motor according to claim 2, wherein
each of the coil groups of n phases includes the first sub coil group and the second sub coil group, and
in each of the coil groups of n phases, the first sub coil group and the second sub coil group are connected in parallel.

4. The motor according to claim 1, wherein the cross-sectional area of the coil included in the coil group of n phases is 1.13 mm² to 3.14 mm².

5. The motor according to claim 4, wherein the outer diameter of the stator is 70 mm to 100 mm, and the wire diameter of the coil included in the coil group of n phases is 1.2 mm to 2.0 mm.

6. The motor according to claim 5, wherein the stator has 12 slots.

7. An electric power steering device comprising the motor according to claim 1.
